(19) United States
(12) Patent Application Publication
(10) Pub. No.: US 2025/0236112 A1
(43) Pub. Date: Jul. 24, 2025

(54) LIQUID DISCHARGE HEAD AND RECORDING APPARATUS

(71) Applicant: CANON KABUSHIKI KAISHA, Tokyo (JP)

(72) Inventors: TOMOKI TSUJI, Kanagawa (JP); TAKUYA IWANO, Tokyo (JP); HIROMASA AMMA, Kanagawa (JP); SHINGO OKUSHIMA, Kanagawa (JP)

(21) Appl. No.: 19/032,994

(22) Filed: Jan. 21, 2025

(30) Foreign Application Priority Data
Jan. 22, 2024 (JP) 2024-007624

(51) Int. Cl. B41J 2/175; B41J 2/14

(52) U.S. Cl. CPC B41J 2/175; B41J 2/14201; B41J 2002/14306

(57) ABSTRACT

A liquid discharge head, including: a first flow path member including a first communication hole; a second flow path member including a second communication hole; and a sealing member which includes an opening portion that forms a flow path connecting the first communication hole and the second communication hole with each other and which is interposed between the first flow path member and the second flow path member, wherein the first flow path member includes a mounting surface on which the first communication hole opens and which extends along a vertical direction and an engaging portion, and the sealing member includes an engaged portion with which the engaging portion is engageable and the sealing member is fixed to the first flow path member along the mounting surface due to an engagement of the engaging portion and the engaged portion.

### BACKGROUND OF THE INVENTION

### Field of the Invention

The present invention relates to a liquid discharge head and a recording apparatus.

### Description of the Related Art

Liquid discharge recording apparatuses such as ink-jet printers have a liquid discharge head (recording head) that discharges a liquid onto a recording medium. In the liquid discharge head, components that form flow paths must be fluidically connected to each other in order to prevent the liquid supplied from a main body of the recording apparatus from leaking outside. As means of fluidically connecting components, for example, as disclosed in Japanese Patent Application Laid-open No. 2004-322417, a configuration of fluidically connecting the components by sandwiching a sealing member between one member and the next is widely known.

### SUMMARY OF THE INVENTION

In the configuration described in Japanese Patent Application Laid-open No. 2004-322417, there is no means for positioning the sealing member at a predetermined mounting position relative to a flow path member during assembly of the liquid discharge head, at least not in the flow path member. Therefore, when a mounting surface of the flow path member on which the sealing member is placed is angled with respect to a horizontal direction before the sealing member is sandwiched between two flow path members, it may be difficult to hold the sealing member on the mounting surface. In particular, when the sealing member is sandwiched in a horizontal direction between two flow path members during the assembly of the liquid discharge head, some kind of means of holding the sealing member at a predetermined mounting position relative to the mounting surface along a vertical direction is necessary to prevent the sealing member from falling off.

In the configuration described in Japanese Patent Application Laid-open No. 2004-322417, the sealing member is assembled between two flow path members by being placed on the mounting surface of one flow path member and placing the other flow path member on top of the sealing member. Therefore, when the mounting surface of the flow path member on which the sealing member is placed is angled with respect to the horizontal direction during the assembly of the liquid discharge head, it may be difficult to hold the sealing member at a predetermined mounting position relative to the mounting surface. In particular, in a configuration in which the sealing member is sandwiched in the horizontal direction between two flow path members so that the mounting surface is oriented in the vertical direction, some kind of means of holding the sealing member at the predetermined mounting position is necessary to prevent the sealing member from falling off.

An object of the present invention is to provide a technique capable of improving assemblability of a flow path member and a sealing member.

In order to achieve the object described above, a liquid discharge head according to the present invention includes:
a first flow path member including a first communication hole;
a second flow path member including a second communication hole; and
a sealing member which includes an opening portion that forms a flow path connecting the first communication hole and the second communication hole with each other and which is interposed between the first flow path member and the second flow path member,
wherein the first flow path member includes a mounting surface on which the first communication hole opens and which extends along a vertical direction and an engaging portion,
wherein the sealing member includes an engaged portion with which the engaging portion is engageable and the sealing member is fixed to the first flow path member along the mounting surface due to an engagement of the engaging portion and the engaged portion.

According to the present invention, assemblability of a flow path member and a sealing member can be improved.

Further features of the present invention will become apparent from the following description of exemplary embodiments with reference to the attached drawings.

### BRIEF DESCRIPTION OF THE DRAWINGS

FIG. 1 is a perspective view of a recording apparatus according to an embodiment of the present invention;

FIG. 2 is a perspective view of a liquid discharge head according to the embodiment of the present invention;

FIG. 3 is a perspective view of the liquid discharge head according to the embodiment of the present invention;

FIG. 4 is an exploded perspective view of the liquid discharge head according to the embodiment of the present invention;

FIG. 5 is an explanatory perspective view of an electrical connection structure of the liquid discharge head according to the embodiment of the present invention;

FIG. 6 is a perspective view of a liquid discharge unit;

FIG. 7 is a perspective view of the liquid discharge unit;

FIG. 8 is an exploded perspective view of the liquid discharge unit;

FIG. 9 is an enlarged view of an electrode portion of the liquid discharge unit;

FIG. 10 is a perspective view of a supporting unit;

FIG. 11 is a plan view of the liquid discharge head as seen from a surface of a discharge unit;

FIG. 12 is a sectional view taken along A-A in FIG. 11;

FIG. 13 is a sectional view taken along B-B in FIG. 11;

FIG. 14 is a sectional view taken along C-C in FIG. 11;

FIGS. 15A and 15B are perspective views showing a liquid connection structure of the liquid discharge head;

FIG. 16 is a sectional view of a liquid connecting portion between a liquid supplying unit and a liquid supplying member;

FIG. 17 is a perspective view showing a liquid connection structure of the supporting unit;

FIG. 18 is a flow path sectional view of the discharge unit;

FIG. 19 is a flow path sectional view inside a recording element substrate;

FIG. 20 is a perspective view of a cooling unit;

FIG. 21 is an exploded perspective view of the cooling unit;

FIG. 22 is a sectional view taken along D-D in FIG. 20;

FIGS. 23A and 23B are sectional views showing an electrical connecting portion between the recording apparatus and the liquid discharge head;

FIGS. 24A and 24B are schematic explanatory diagrams of a sealing member according to the embodiment of the present invention;

FIGS. 25A and 25B are schematic explanatory diagrams of a refrigerant supplying member according to the embodiment of the present invention;

FIGS. 26A and 26B are schematic explanatory diagrams of the refrigerant supplying member according to the embodiment of the present invention;

FIGS. 27A and 27B are schematic explanatory diagrams of a second refrigerant supplying member and the sealing member according to the embodiment of the present invention;

FIG. 28 is a sectional view taken along J-J in FIG. 20;

FIGS. 29A and 29B are schematic explanatory diagrams of the second refrigerant supplying member and the sealing member according to a first modification;

FIGS. 30A and 30B are schematic explanatory diagrams of the second refrigerant supplying member and the sealing member according to a second modification;

FIG. 31 is a schematic explanatory diagram of the second refrigerant supplying member and the sealing member according to a third modification;

FIGS. 32A and 32B are schematic explanatory diagrams of the sealing member according to the third modification;

FIG. 33 is a schematic explanatory diagram of the second refrigerant supplying member according to the third modification;

FIGS. 34A to 34C are schematic explanatory diagrams of the second refrigerant supplying member and the sealing member according to a fourth modification;

FIG. 35 is a schematic explanatory diagram of the second refrigerant supplying member and the sealing member according to a fifth modification;

FIG. 36 is a schematic explanatory diagram of the sealing member according to the fifth modification;

FIG. 37 is a schematic explanatory diagram of the second refrigerant supplying member according to the fifth modification; and

FIGS. 38A and 38B are schematic explanatory diagrams of the sealing member according to a sixth modification.

### DESCRIPTION OF THE EMBODIMENTS

A mode for implementing the present invention will now be exemplarily described in detail based on examples with reference to the drawings. It is to be understood that dimensions, materials, shapes, relative arrangements, and the like of components described in the embodiment are intended to be changed as deemed appropriate in accordance with configurations and various conditions of apparatuses to which the present invention is to be applied. In other words, the scope of the present invention is not intended to be limited to the embodiment described below.

While a plurality of features are described in the embodiment and respective modifications presented below, all of the plurality of features are not necessarily essential to the invention and the plurality of features may be combined with each other in any way. Moreover, in the accompanying drawings, a same reference numeral will be assigned to a same or similar component between the embodiment and the respective modifications and overlapping descriptions will be omitted.

Note that in this specification, a “record” (which may also be referred to as a “print”) is not limited to only forming significant information such as characters and graphics and includes forming both significant and insignificant information. A “record” also widely represents cases where an image, a design, a pattern, or the like is formed on a recording medium or where the medium is processed irrespective of whether or not the information is manifested in a way that is visually perceivable by humans. In addition, a “recording medium” not only represents paper that is used in general recording apparatuses but also widely represents media capable of accepting ink such as cloth, plastic films, metal plates, glass, ceramics, wood, and leather.

Furthermore, “ink” (which may also be referred to as a “liquid”) is to be widely interpreted in a similar manner to the definition of a “record (print)” described above. Therefore, “ink” represents a liquid that, by being applied onto a recording medium, can be used to form an image, a design, a pattern, or the like or to process the recording medium, or to process the ink (for example, solidifying or insolubilizing a coloring material in the ink applied to the recording medium). Moreover, unless otherwise specified, a “recording element” collectively refers to a discharge port, a liquid channel communicated to the discharge port, and an element that generates energy used for ink discharge. In addition, unless otherwise specified, a “nozzle” collectively refers to a discharge port, a liquid channel communicated to the discharge port, and an element that generates energy used for ink discharge.

An element substrate for a recording head (head substrate) used hereinafter does not refer to a simple substrate made of a silicon semiconductor but, rather, refers to a construction provided with each element, wiring, and the like. Furthermore, “on the substrate” refers not only to on top of the element substrate but also to a surface of the element substrate and an interior side of the element substrate in a vicinity of the surface.

While a liquid discharge head adopting a method of discharging a liquid by driving a piezoelectric element is exemplified as an example of a liquid discharge method in the present embodiment, liquid discharge heads to which the present invention can be applied are not limited thereto. The present invention can also be applied to liquid discharge heads adopting a thermal method in which a liquid is discharged by bubbles generated by a heater element or other various liquid discharge methods.

While the present embodiment represents an inkjet recording apparatus (recording apparatus) configured to circulate a liquid such as ink between a tank and a liquid discharge head, the recording apparatus may be configured differently. For example, instead of circulating ink, the inkjet recording apparatus may be provided with two tanks, respectively, on an upstream side and a downstream side of a liquid discharge head and configured to cause ink inside a pressure chamber to flow by supplying the ink from one tank to the other.

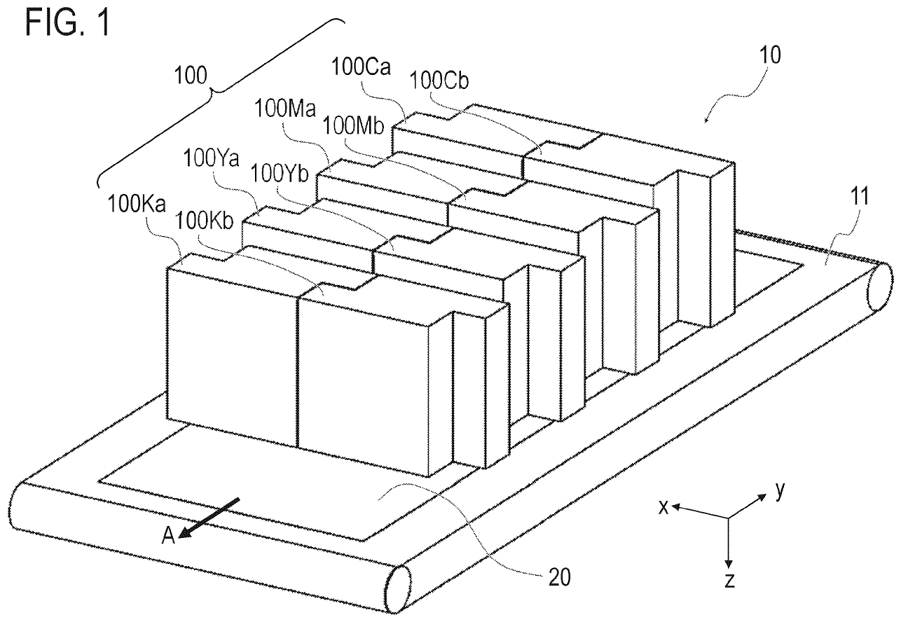

FIG. 1 is a schematic perspective view showing an example of a recording apparatus 10 according to the present embodiment. The recording apparatus 10 according to the present embodiment is a one-pass type recording apparatus that records an image on a recording medium in a single movement of the recording medium, and nozzles are arrayed across a side corresponding to a full width of a recording medium 20. The recording medium 20 is conveyed in a direction of an arrow A by a conveyance portion 11 and recording is performed by a liquid discharge head 100. The recording apparatus 10 according to the present embodiment is a full-color ink-jet printer capable of recording in any color by combining yellow (Y), magenta (M), cyan (C), and black (K) inks.

The liquid discharge head 100 according to the present embodiment is constituted of a plurality of liquid discharge heads 100Y, 100M, 100C, and 100K corresponding to yellow (Y), magenta (M), cyan (C), and black (K) inks. In other words, the liquid discharge head 100Y is a liquid discharge head for discharging yellow ink. In a similar manner, the liquid discharge head 100M discharges magenta ink, the liquid discharge head 100C discharges cyan ink, and the liquid discharge head 100K discharges black ink. In addition, the liquid discharge head 100Y is configured so that a liquid discharge head 100Ya arranged on one side and a liquid discharge head 100Yb arranged on another side in a width direction of a recording medium that is orthogonal to a conveying direction of the recording medium are aligned in the width direction. The liquid discharge heads 100M, 100C, and 100K are configured in a similar manner. The liquid discharge heads 100Y, 100M, 100C, and 100K are configured with the same structure as each other, the sole difference being the color of ink to be discharged.

The configuration of the liquid discharge head 100 shown in FIG. 1 is simply an example and the present invention is applicable to liquid discharge heads configured in any way including the example shown in FIG. 1. In other words, the present invention is suitably applicable even if the liquid discharge head adopts other configurations that differ from FIG. 1.

### Embodiment

A configuration of the liquid discharge head 100 according to the present embodiment will be described. As described above, the recording apparatus 10 according to the present embodiment includes a plurality of liquid discharge heads 100Ya, 100Yb, 100Ma, 100Mb, 100Ca, 100Cb, 100Ka, and 100Kb and the liquid discharge heads have a same structure as each other. Here, a configuration of one of the plurality of liquid discharge heads 100Ya, 100Yb, 100Ma, 100Mb, 100Ca, 100Cb, 100Ka, and 100Kb will be described.

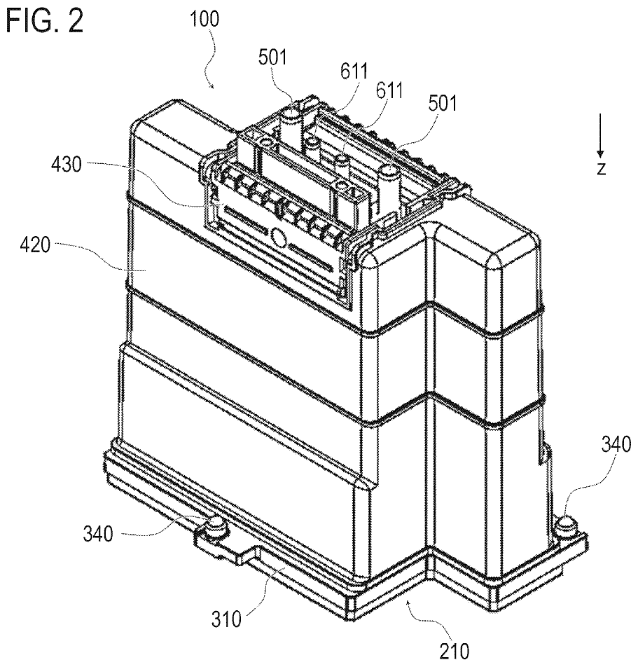

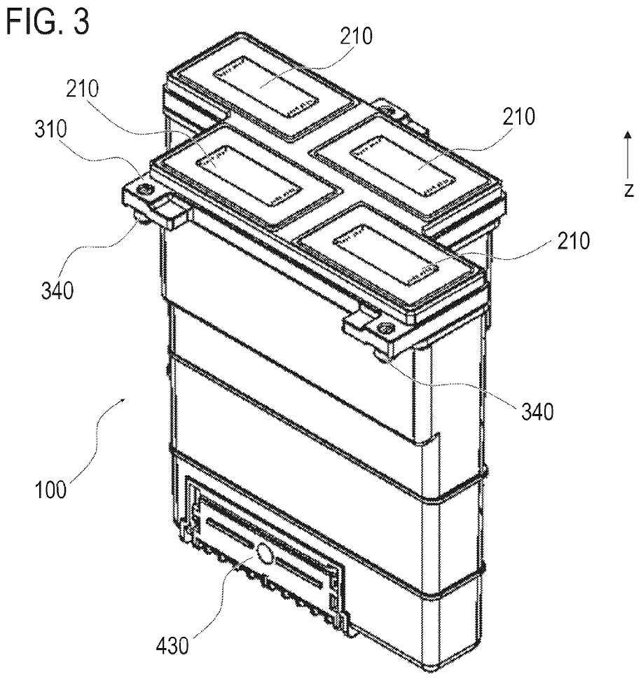

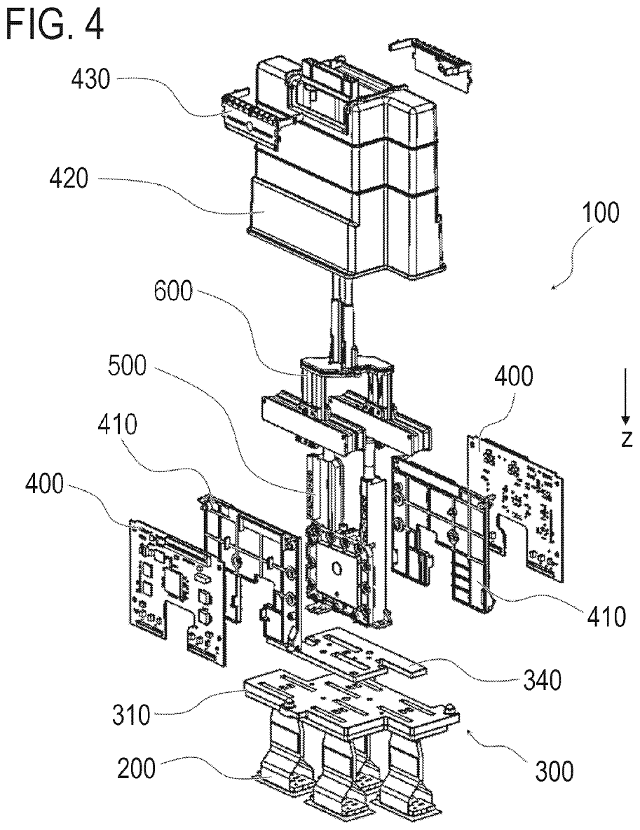

FIG. 2 is a perspective view of the liquid discharge head 100 according to the present embodiment, showing the liquid discharge head 100 in a posture in which an up-down direction of the drawing coincides with a vertical direction (+z direction) and a discharge surface on which a plurality of discharge ports are lined up and which opposes the recording medium 20 is positioned downward (faces downward). FIG. 3 is a perspective view of the liquid discharge head 100 according to the present embodiment, showing the liquid discharge head 100 in a posture in which the up-down direction of the drawing coincides with an opposite direction to the vertical direction (−z direction) and the discharge surface on which the plurality of discharge ports are lined up and which opposes the recording medium 20 is positioned upward (faces upward). FIG. 4 is an exploded perspective view of the liquid discharge head 100.

As shown in FIGS. 2 and 3, the liquid discharge head 100 includes four recording element substrates 210 capable of discharging a liquid from a discharge surface on which a plurality of discharge ports (nozzles) are formed. The four recording element substrates 210 are arrayed in a staggered pattern on a supporting member 310. The liquid discharge head 100 is positioned in the recording apparatus 10 by a reference member 340. A liquid connecting portion 501 and a refrigerant connecting portion 611 are provided in an upper part of the liquid discharge head 100. In the liquid discharge head 100, due to the liquid connecting portion 501 being connected to a liquid supplying portion of the recording apparatus, a liquid such as ink is supplied into the liquid discharge head 100. In a similar manner, in the liquid discharge head 100, due to the refrigerant connecting portion 611 being connected to a refrigerant supplying portion of the recording apparatus, a refrigerant is supplied into the liquid discharge head 100. In addition, the liquid discharge head 100 includes a cover member 420 and a cover member 430 for covering and protecting electrical substrates, electrical connecting portions, and the like as head exterior portions.

As shown in FIG. 4, as internal components, the liquid discharge head 100 includes a supporting unit 300, an electric wiring substrate 400, an electric wiring substrate supporting member 410, a liquid supplying unit 500, and a cooling unit 600. The supporting unit 300 includes the supporting member 310. The electric wiring substrate 400 is supported by the electric wiring substrate supporting member 410. The liquid supplying unit 500 supplies a liquid to a liquid discharge unit 200 via the electric wiring substrate supporting member 410 and the supporting unit 300. The cooling unit 600 cools a drive circuit. Hereafter, a configuration of each segment of the liquid discharge head 100 will be described in detail.

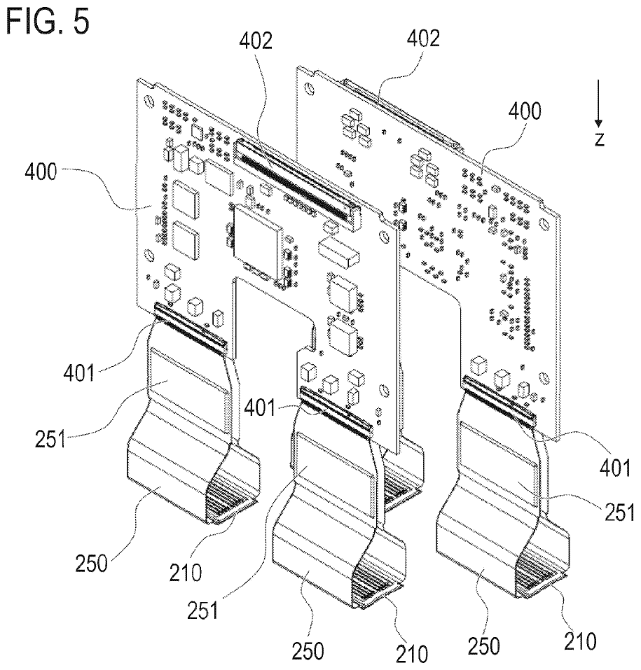

FIG. 5 is a configuration diagram of an electrical connection of the liquid discharge head 100 according to the present embodiment. The recording apparatus 10 and the recording element substrate 210 are electrically connected via a flexible wiring substrate 250 and the electric wiring substrate 400. The electric wiring substrate 400 is electrically connected to a control portion of the recording apparatus by an electric connecting terminal 402 and a discharge drive signal and power necessary for discharge are supplied from a recording apparatus main body to the recording element substrate 210. The electric wiring substrate 400 and the flexible wiring substrate 250 are electrically connected by an electric connecting portion 401. Consolidating wiring by the electrical circuits in the electric wiring substrate 400 enables the number of terminals of the electric connecting terminal 402 to be reduced as compared to the number of terminals of the recording element substrate 210. Accordingly, the number of electric connecting portions that need to be disconnected when assembling the liquid discharge head 100 to the recording apparatus 10 or replacing the liquid discharge head can be reduced.

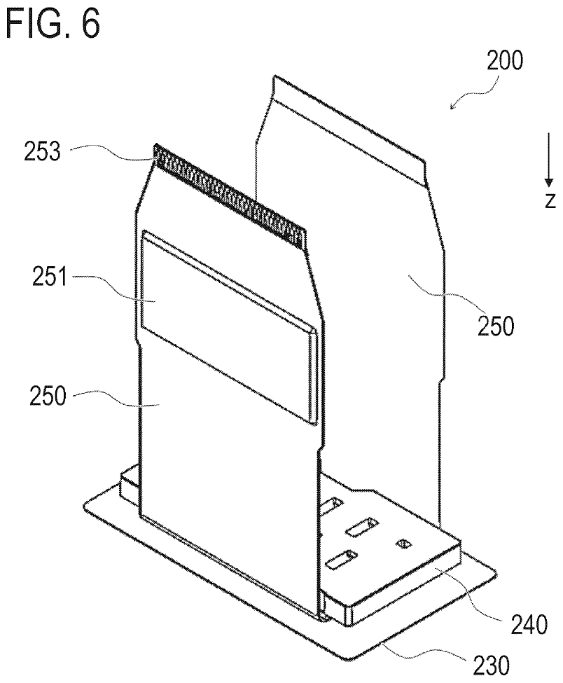

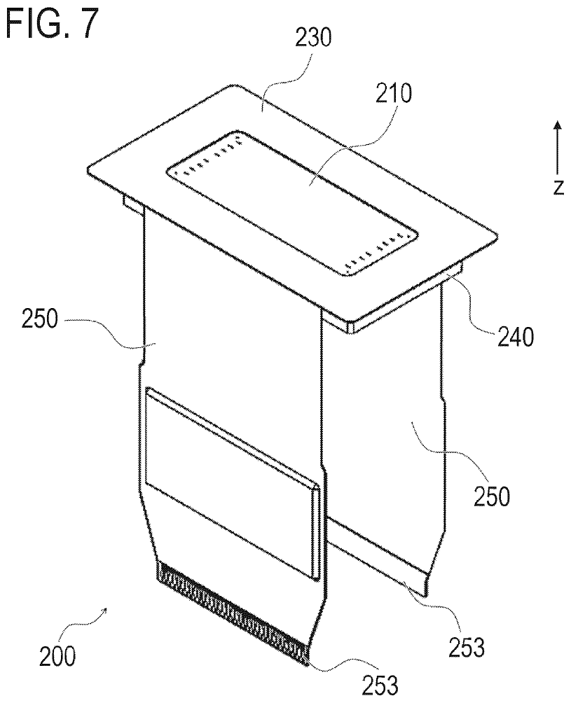

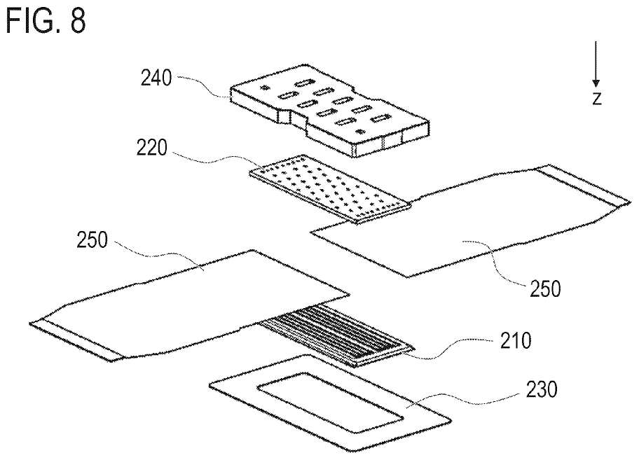

FIG. 6 is a perspective view of the liquid discharge unit 200, showing the liquid discharge unit 200 in a state in which an up-down direction of the drawing coincides with the vertical direction (+z direction) and a discharge surface on which a plurality of discharge ports are lined up and which opposes the recording medium 20 is positioned downward (faces downward). FIG. 7 is a perspective view of the liquid discharge unit 200, showing the liquid discharge unit 200 in a state in which an up-down direction of the drawing coincides with the vertical direction (−z direction) and a discharge surface on which a plurality of discharge ports are lined up and which opposes the recording medium 20 is positioned upward (faces upward). FIG. 8 is an exploded perspective view of the liquid discharge unit 200.

The liquid discharge unit 200 is constituted of the recording element substrate 210 that discharges a liquid, a recording element substrate flow path member 220, a recording element substrate supporting member 230, a flow path member 240, and the flexible wiring substrate 250. The recording element substrate flow path member 220 supplies a liquid to the recording element substrate 210. The flexible wiring substrate 250 is electrically connected to the recording element substrate 210. The recording element substrate supporting member 230 is bonded to a discharge surface side of the recording element substrate 210.

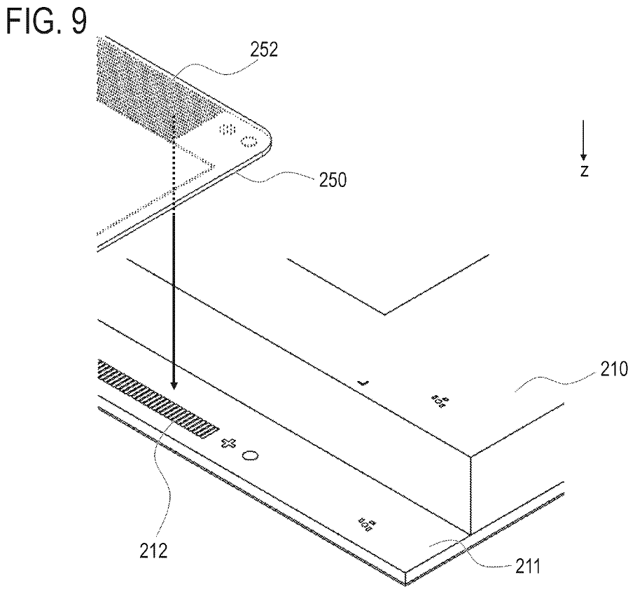

As shown in FIG. 9, an electrode portion 212 is provided in a thin-plate portion 211 at both ends of the recording element substrate 210. Due to the electrode portion 212 bringing electrodes of the recording element substrate 210 and a first electric connecting portion 252 of the flexible wiring substrate 250 into contact with each other, the recording element substrate 210 and the flexible wiring substrate 250 are electrically connected to each other. The recording element substrate supporting member 230 is bonded to a discharge surface side of the thin-plate portion 211 of the recording element substrate 210 in order to prevent the liquid from infiltrating the electric connecting portion and to reinforce the thin-plate portion 211. The flexible wiring substrate 250 is provided with a drive circuit substrate 251 for driving a recording element of the recording element substrate 210.

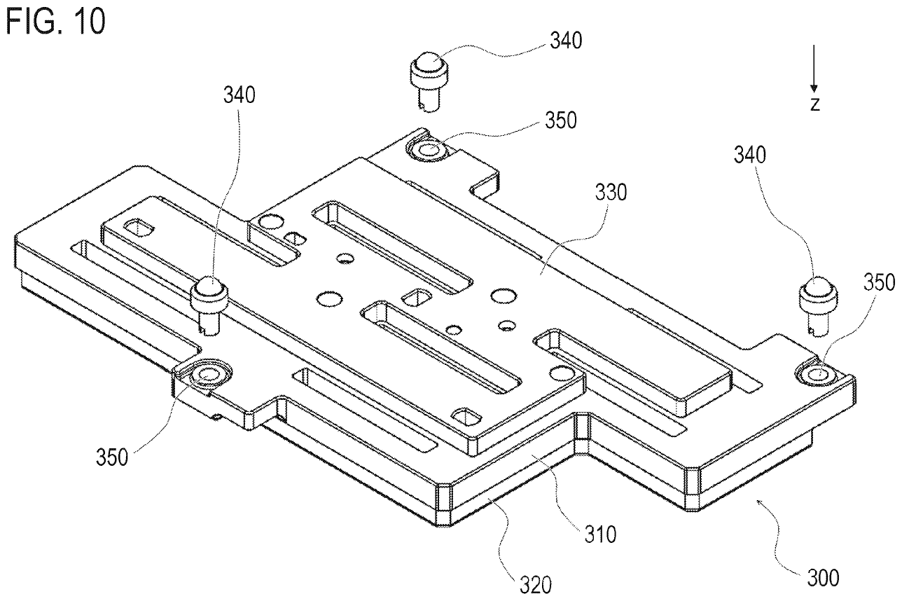

FIG. 10 is a perspective view of the supporting unit 300 that supports the liquid discharge unit 200. The supporting unit 300 is constituted of the supporting member 310, a frame body member 320, a liquid supplying member 330, the reference member 340, and a reference fixing member 350. The liquid discharge unit 200 is bonded to the supporting member 310. The frame body member 320 surrounds a periphery of the liquid discharge unit 200. In the liquid supplying member 330, a flow path that supplies the liquid to each liquid discharge unit 200 via the supporting member 310 is formed. The reference member 340 has a positioning function for positioning the liquid discharge unit 200 with respect to the recording apparatus 10. The reference fixing member 350 fixes the reference member 340 to the supporting member 310. Preferably, in consideration of effects of thermal expansion during ink heating and temperature control, due to environmental changes, and the like, a same member is used as the supporting member 310, the frame body member 320, and the liquid supplying member 330 or, when different members are to be used, members with linear expansion coefficients that are as close as possible are selected. Accordingly, deformation of the entire support unit during thermal expansion and a resulting deterioration of positioning accuracy of the recording element substrate 210 can be suppressed.

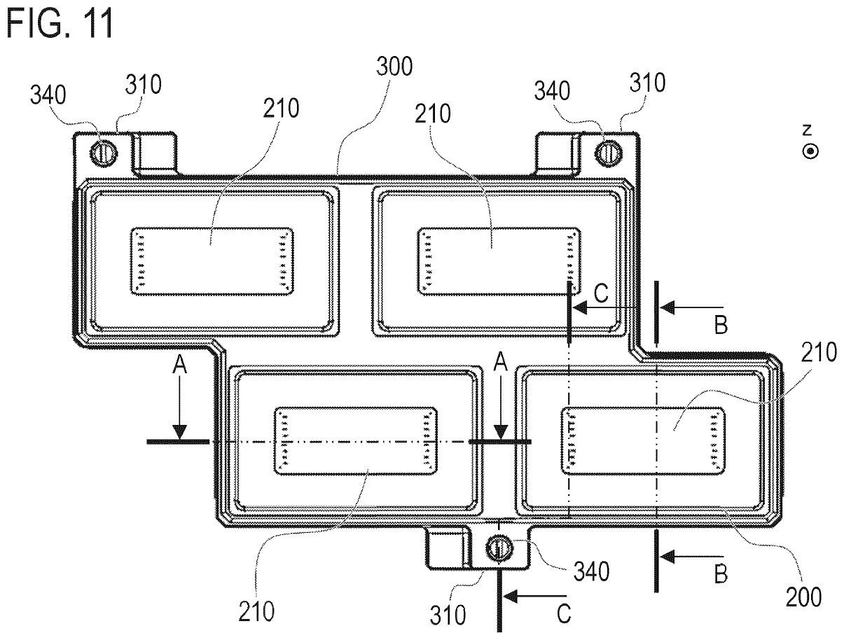

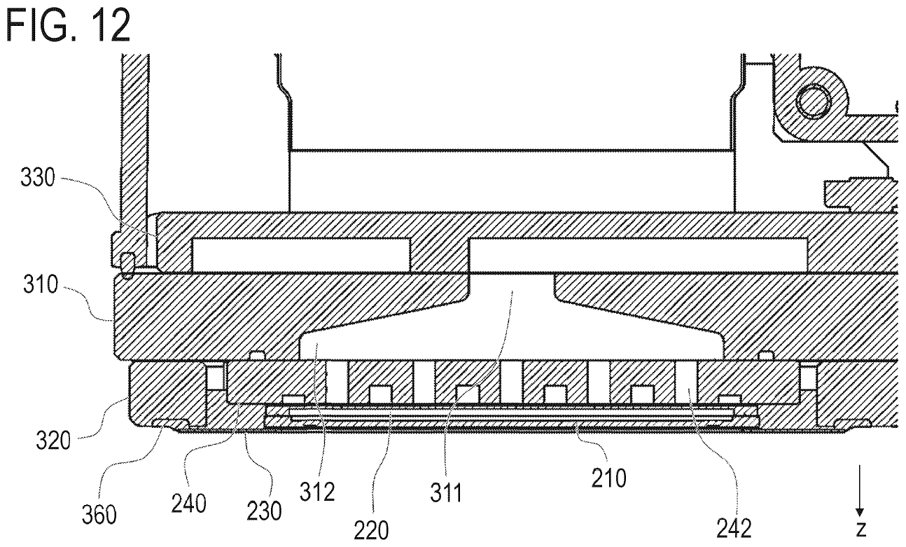

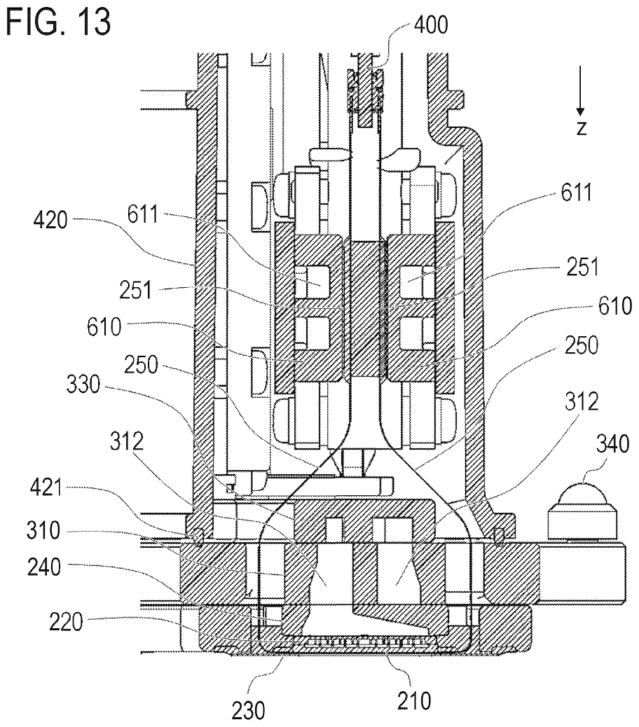

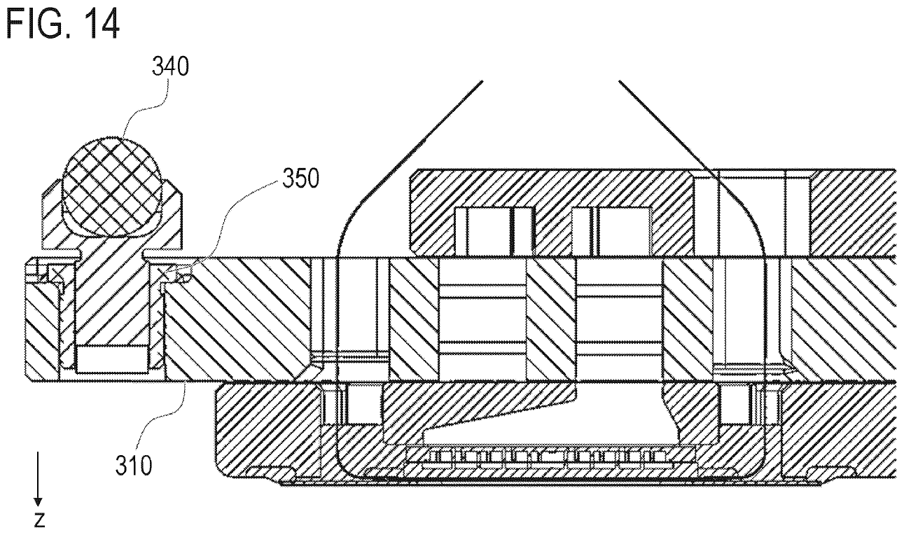

FIG. 11 is a plan view of the liquid discharge head 100 in which the liquid discharge unit 200 is assembled to the supporting unit 300 as seen from a side of the discharge surface. FIG. 12 is a sectional view taken along A-A in FIG. 11. FIG. 13 is a sectional view taken along B-B in FIG. 11. FIG. 14 is a sectional view taken along C-C in FIG. 11. The flow path member 240 and the liquid supplying member 330 are bonded to the supporting member 310 and each liquid flow path is fluidically connected. In a periphery of the recording element substrate supporting member 230, a space between the recording element substrate supporting member 230 and the frame body member 320 is sealed by a periphery sealing member (not illustrated) in order to prevent liquid infiltration. A rear surface of the recording element substrate supporting member 230 may be sealed by a rear surface sealing member (not illustrated) for reinforcement. The supporting member 310 has three holes for inserting the reference fixing member 350, realizing a configuration in which the reference fixing member 350 is fixed to the holes and the reference member 340 is fixed to the reference fixing member 350. The reference fixing member 350 and the supporting member 310 may be an integrated component.

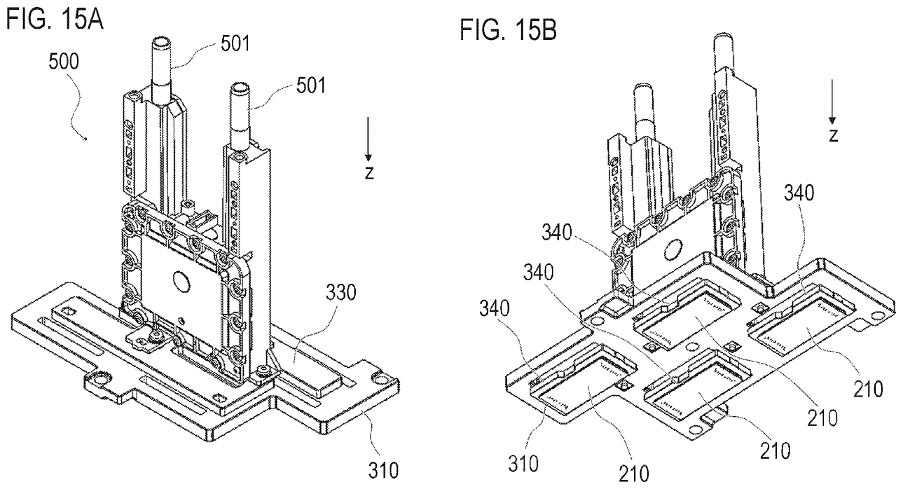

FIGS. 15A and 15B are diagrams showing a liquid member connection structure of the liquid discharge head 100 according to the present embodiment, in which FIG. 15A is a perspective view of the liquid supplying unit 500 when looking down from diagonally above and FIG. 15B is a perspective view of the liquid supplying unit 500 when looking up from diagonally below. The liquid supplying unit 500 includes the liquid connecting portion 501 and is connected to a liquid supply system of the recording apparatus 10. Accordingly, the liquid is supplied from the supply system of the recording apparatus 10 to the liquid discharge head 100 and, additionally, the liquid having passed inside the liquid discharge head 100 is collected to the supply system of the recording apparatus 10. In this manner, the liquid can circulate via a path of the recording apparatus 10 and a path of the liquid discharge head 100. A filter (not illustrated) communicated with each opening of the liquid connecting portion 501 is provided inside the liquid supplying unit 500 in order to remove foreign objects in supplied ink.

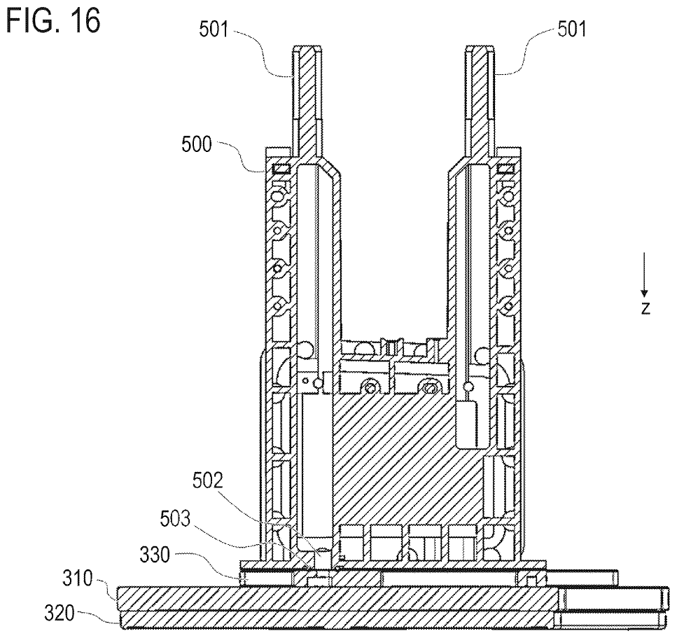

FIG. 16 is a sectional view of a liquid connecting portion between the liquid supplying unit 500 and the liquid supplying member 330. The liquid that flows in from the side of the recording apparatus through the liquid connecting portion 501 passes through a communication port 502 and is supplied to the liquid supplying member 330. A space between the liquid supplying unit 500 and the liquid supplying member 330 is sealed by an elastic member 503.

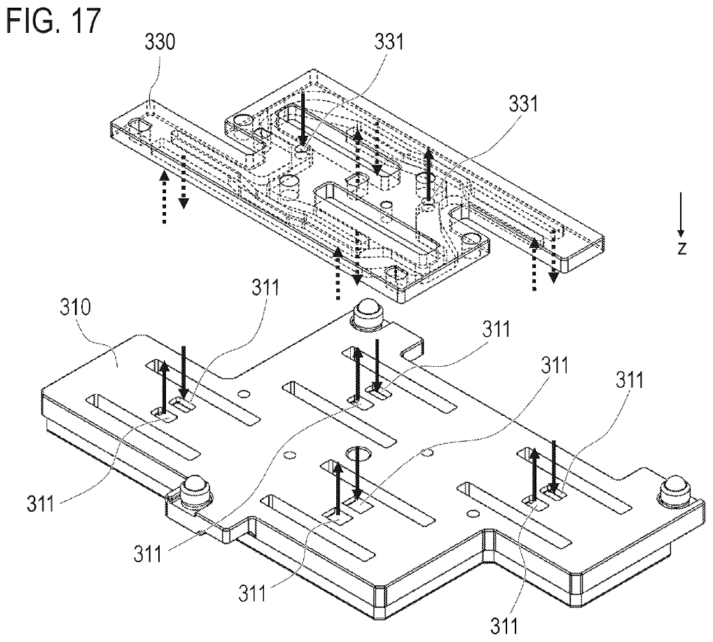

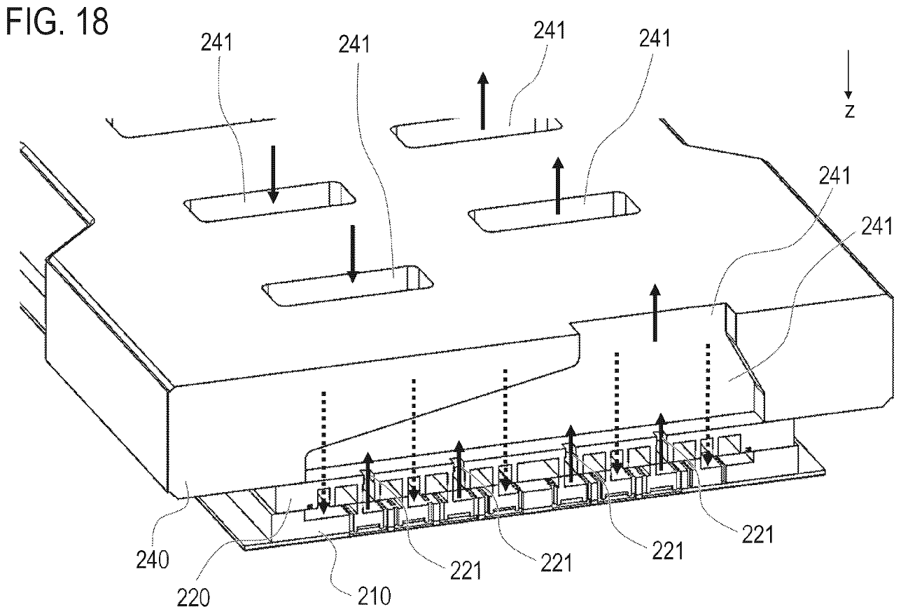

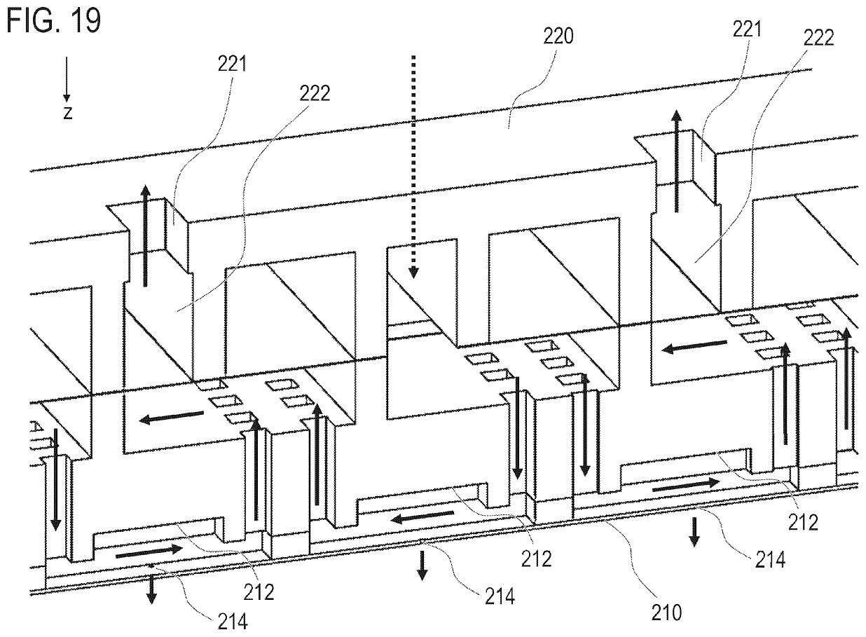

FIG. 17 is an exploded perspective view showing a liquid member connection structure of the supporting unit 300 and FIG. 18 is a perspective view showing a liquid member connection structure of the liquid discharge unit 200. The liquid supplying unit 500 and the liquid supplying member 330 are fluidically connected by a communication port 331. In the liquid supplying member 330, a flow path (depicted by a dashed line in FIG. 17) that distributes the liquid to each liquid discharge unit 200 is formed. The liquid supplying member 330 and the supporting member 310 are fluidically connected by a communication port 311. The supporting member 310 and each liquid discharge unit 200 are fluidically connected by a communication port 241 of the flow path member 240. A liquid flow path 242 is formed inside the flow path member 240 and the liquid flow path 242 is fluidically connected to the recording element substrate flow path member 220 via a communication port 221. FIG. 19 shows a fluid connection structure inside the recording element

substrate 210. The liquid having flowed in from each communication port 221 passes through a common flow path 222 and is supplied to the recording element substrate 210, and is discharged from a discharge port 213 by discharge energy generated by an operation of a piezoelectric element 214.

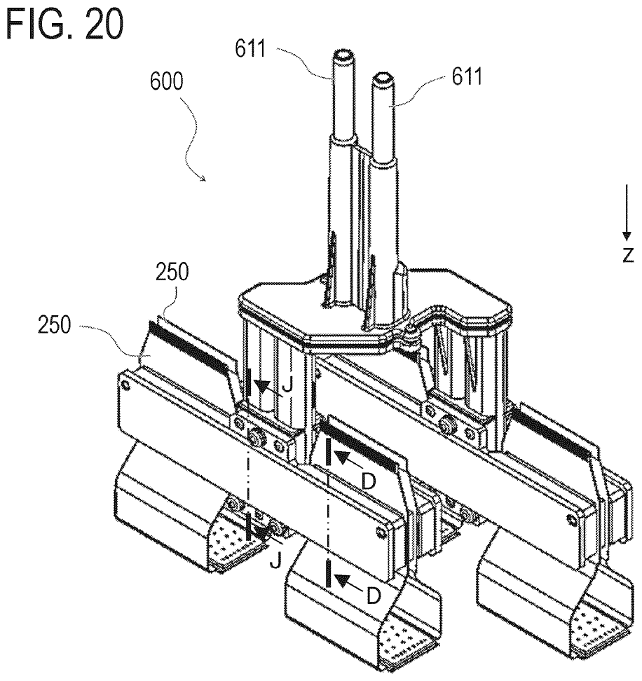

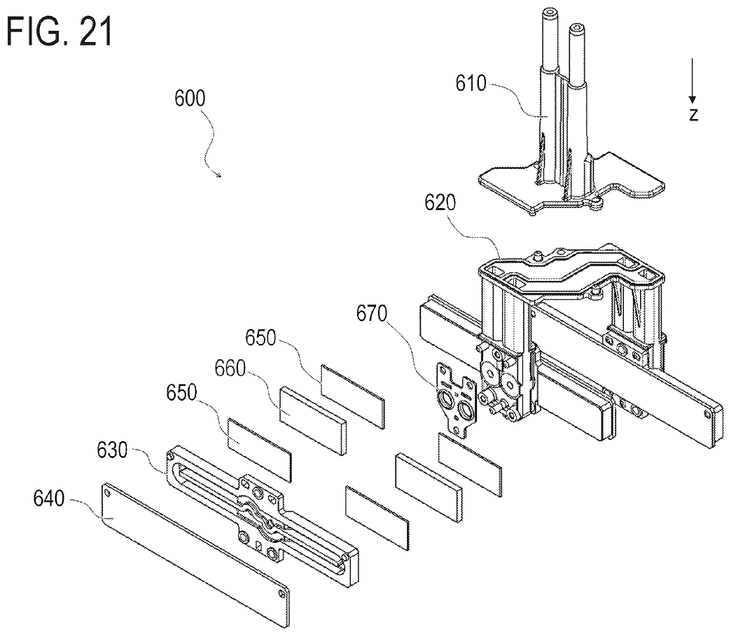

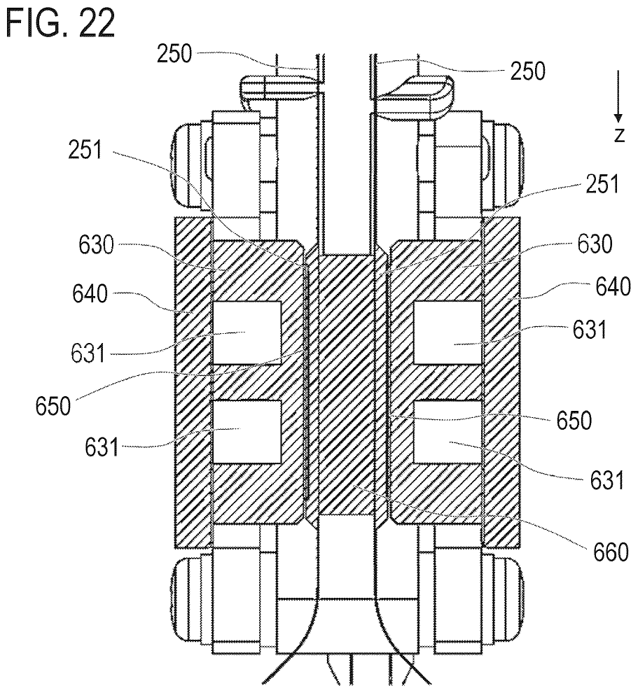

FIG. 20 is a perspective view of the cooling unit 600 for cooling the drive circuit substrate 251. FIG. 21 is an exploded perspective view of the cooling unit 600, and FIG. 22 is a sectional view taken along D-D in FIG. 20. The cooling unit 600 includes the refrigerant connecting portion 611 and is connected to a refrigerant supply system of the recording apparatus 10. Accordingly, the refrigerant is supplied from the refrigerant supply system of the recording apparatus 10 to the cooling unit 600 and, additionally, the refrigerant having passed inside the cooling unit 600 is collected to the refrigerant supply system of the recording apparatus 10. In this manner, the refrigerant can circulate via a path of the recording apparatus 10 and a path of the cooling unit 600. The refrigerant having flowed in from the refrigerant connecting portion 611 is branched by a refrigerant flow path formed between a first refrigerant supplying member 610 and a second refrigerant supplying member 620. The second refrigerant supplying member 620 and a first cooling member 630 are fluidically connected via a sealing member 670. The refrigerant having branched inside the second refrigerant supplying member 620 circulates in a refrigerant flow path formed between the first cooling member 630 and a second cooling member 640 and once again flows into the second refrigerant supplying member 620. The first cooling member 630 is configured to transfer heat generated during an operation of the drive circuit substrate 251 to the refrigerant inside the first cooling member 630 by coming into contact with the drive circuit substrate 251 with a heat conducting member 650 sandwiched therebetween. An elastic member 660 is provided between the two flexible wiring substrates 250 and, accordingly, the heat conducting member 650 can be reliably brought into close contact with the drive circuit substrate 251. Preferably, a member with a highest possible thermal conductivity such as aluminum is selected as the first cooling member 630 in order to facilitate the transfer of heat generated by the drive circuit substrate 251.

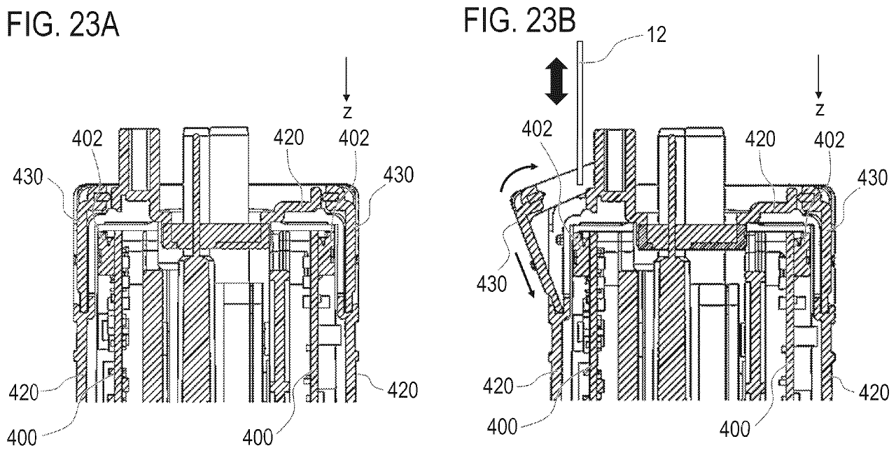

FIGS. 23A and 23B are sectional views showing an electrical connecting portion between the recording apparatus 10 and the liquid discharge head 100, in which FIG. 23A shows a state before the liquid discharge head 100 is electrically connected to the recording apparatus 10 and FIG. 23B shows a situation when the liquid discharge head 100 is electrically connected to the recording apparatus 10. The electric connecting terminal 402 is constructed on the electric wiring substrate 400 inside the liquid discharge head 100 and establishes electrical connection by being connected to an electric wiring portion 12 provided in the recording apparatus main body. A periphery (electric connecting portion) of the electric connecting terminal 402 is configured to be covered by the cover member 430 that is openable and closable. FIG. 23B shows a situation where the cover member 430 is opened.

### Description Regarding Configuration of Sealing Member and Refrigerant Supplying Member

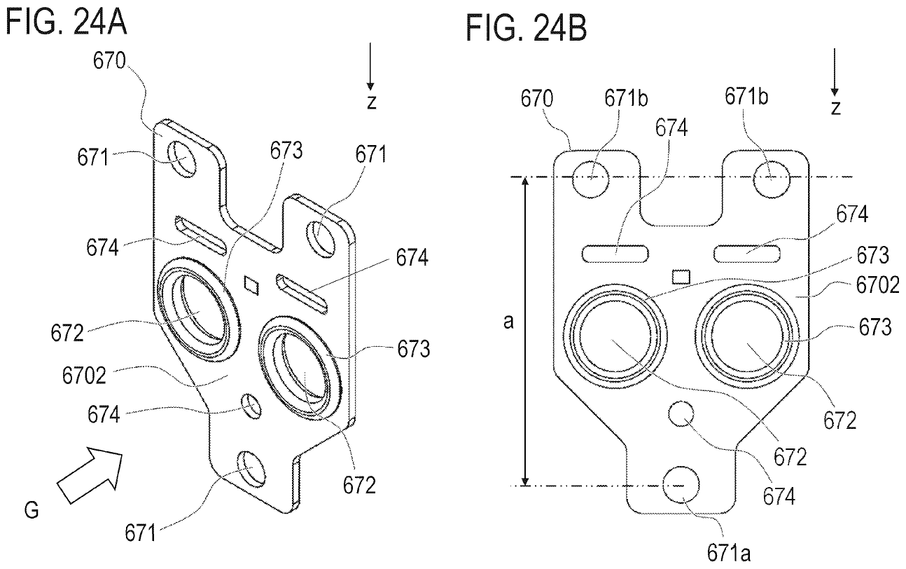

A configuration of the sealing member 670 and the second refrigerant supplying member 620 will be described using FIGS. 24A and 24B to 28.

FIGS. 24A and 24B are diagrams showing the sealing member 670 according to the present embodiment, in which FIG. 24A is a schematic perspective view and FIG. 24B is a view along an arrow G in FIG. 24A. The sealing member 670 includes three engaged portions 671 and two opening portions 672. Each engaged portion 671 is configured so that an engaging portion 621 of the second refrigerant supplying member 620 is engageable with the engaged portion 671. In addition, the sealing member 670 includes a second opening portion 674 between each engaged portion 671 and each opening portion 672. Furthermore, a contact portion 673 is provided in a periphery of the opening 672.

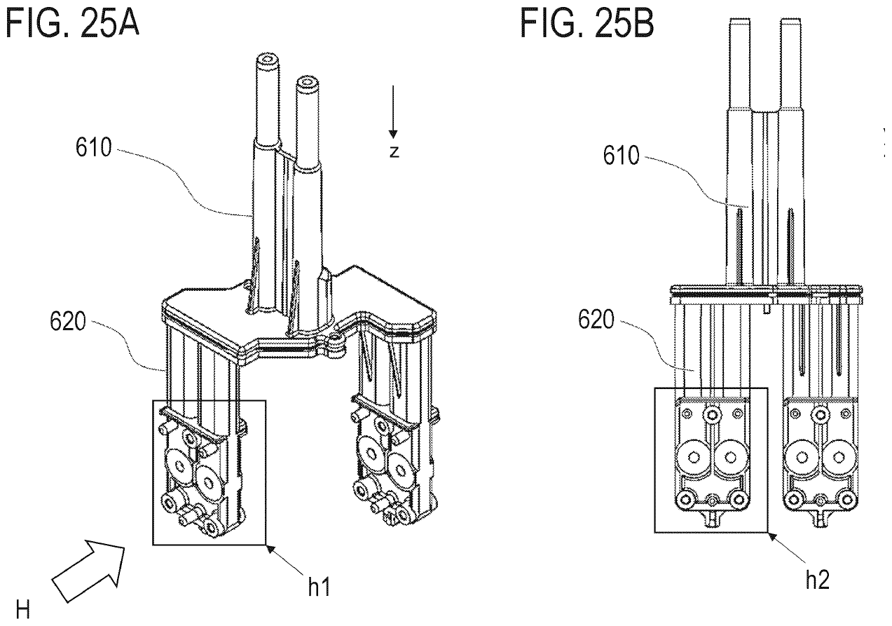

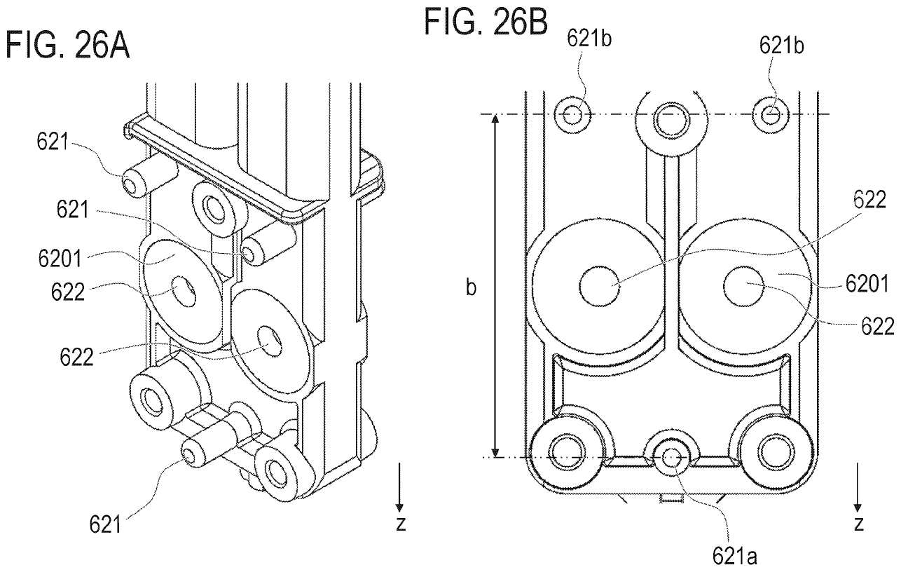

FIGS. 25A and 25B are diagrams showing the first refrigerant supplying member 610 and the second refrigerant supplying member 620 according to the present embodiment, in which FIG. 25A is a schematic perspective view and FIG. 25B is a view along an arrow H in FIG. 25A. FIGS. 26A and 26B are diagrams showing the first refrigerant supplying member 610 and the second refrigerant supplying member 620 according to the present embodiment, in which FIG. 26A is a partial enlarged view of an h1 portion in FIG. 25A and FIG. 26B is a partial enlarged view of an h2 portion in FIG. 25B. The second refrigerant supplying member 620 includes three engaging portions 621 and two first communication ports 622.

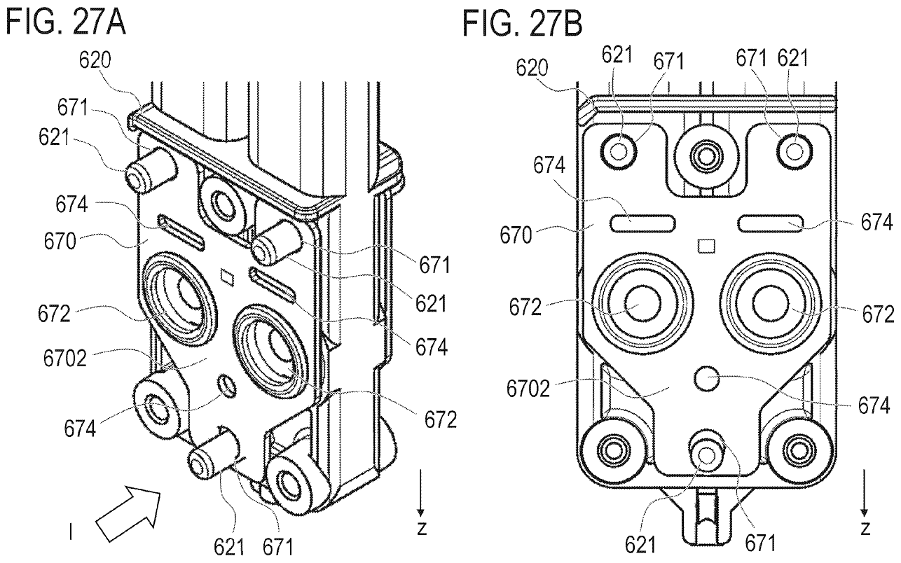

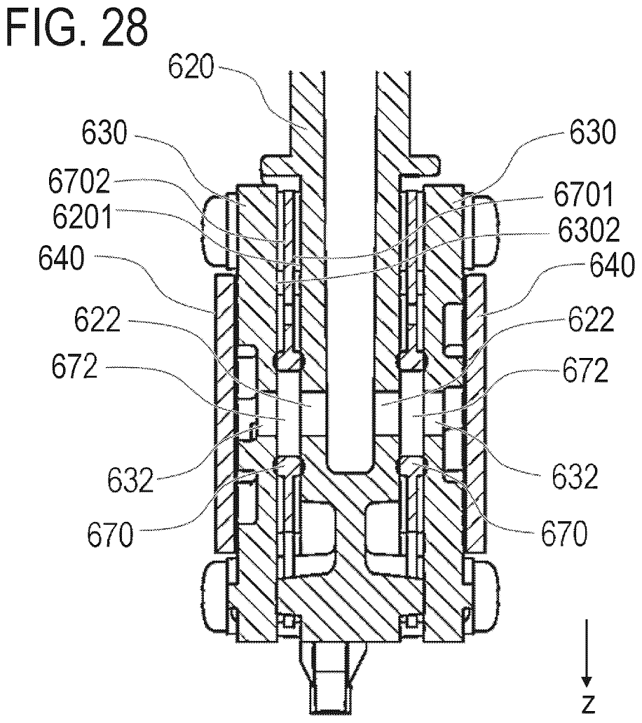

FIGS. 27A and 27B are diagrams showing a situation where the sealing member 670 is mounted to the second refrigerant supplying member 620, in which FIG. 27A is a schematic perspective view and FIG. 27B is a view along an arrow I in FIG. 27A. In addition, FIG. 28 is a sectional view taken along J-J in FIG. 20.

The sealing member 670 is fixed (positioned) with respect to the second refrigerant supplying member 620 as each engaged portion 671 engages with each engaging portion 621 provided on the second refrigerant supplying member 620 as a first flow path member. Furthermore, the first cooling member 630 as a second flow path member and the second cooling member 640 are assembled to the second refrigerant supplying member 620 so as to sandwich the sealing member 670. The sealing member 670 is mounted so as to be sandwiched at a predetermined mounting position between the second refrigerant supplying member 620 and the first cooling member 630.

The second refrigerant supplying member 620 is provided with the first communication port 622 as a first communication hole and the first cooling member 630 is provided with a second communication port 632 as a second communication hole. The opening 672 provided on the sealing member 670 interposed between the second refrigerant supplying member 620 and the first cooling member 630 becomes a portion that forms a flow path connecting the first communication port 622 of the second refrigerant supplying member 620 and the second communication port 632 of the first cooling member 630.

The contact portion 673 that is a protruded portion formed in an approximately annular shape so as to surround the opening 672 is provided on an outer periphery of the opening 672. The sealing member 670 includes an opposing surface 6701 (first opposing surface) that opposes the second refrigerant supplying member 620 and an opposing surface 6702 (second opposing surface) that opposes the first cooling member 630. The contact portion 673 is provided on each of the opposing surfaces 6701 and 6702. In other words, the contact portion 673 includes a first contact portion provided on the opposing surface 6701 and a second contact portion provided on the opposing surface 6702. A thickness of the sealing member 670 in an area where the sealing member 670 is sandwiched between the second refrigerant supplying member 620 and the first cooling member 630 is locally thick at locations where the contact portion 673 is provided. In other words, the sealing member 670 is to be elastically compressed between the second refrigerant supplying member 620 (mounting surface 6201) and the first cooling member 630 (mounting surface 6302), particularly at locations where the contact portion 673 is provided. As described above, due to the contact portion 673 coming into contact with the second refrigerant supplying member 620 and the first cooling member 630, the opening 672 of the sealing member 670 is changed to a state where the opening 672 fluidically connects the first communication port 622 and the second communication port 632 in a liquid-tight manner.

The mounting surface 6201 (first mounting surface) of the sealing member 670 in the second refrigerant supplying member 620 and the mounting surface 6302 (second mounting surface) of the sealing member 670 in the first cooling member 630 are, respectively, surfaces that extend in a vertical direction (z direction). The sealing member 670 is to be sandwiched between the second refrigerant supplying member 620 and the first cooling member 630 in a posture where the opposing surfaces 6701 and 6702 extend along the vertical direction. Therefore, the first communication port 622 of the second refrigerant supplying member 620 and the second communication port 632 of the first cooling member 630 are to be fluidically connected in a direction perpendicular to the vertical direction via the opening 672 of the sealing member 670.

The engaging portion 621 of the second refrigerant supplying member 620 is a projected portion that protrudes from the mounting surface of the sealing member 670 in the second refrigerant supplying member 620. The engaged portion 671 of the sealing member 670 is a hole portion into which the engaging portion 621 of the second refrigerant supplying member 620 can be inserted. A combination of the engaging portion 621 and the engaged portion 671 is provided in plurality and, in the present example, three combinations are provided.

A distance “a” between the engaged portions 671 provided in plurality in the sealing member 670 is shorter than a distance “b” between the engaging portions 621 provided in plurality in the second refrigerant supplying member 620. More specifically, the distance “a” is provided in the vertical direction between an engaged portion 671a (first engaged portion) arranged on one side in the vertical direction across the opening 672 and an engaged portion 671b (second engaged portion) arranged on another side among the plurality of engaged portions 671. Note that while a distance between centers of holes of the engaged portions 671 is defined as the distance “a” in the present example, a criterion for measuring the distance “a” is not limited thereto. In a similar manner, the distance “b” is provided in the vertical direction between an engaging portion 621a (first engaging portion) arranged on one side in the vertical direction across the first communication port 622 and an engaging portion 621b (second engaging portion) arranged on another side among the plurality of engaging portions 621. Note that while a distance between centers of circular cross sections of the engaging portions 621 is defined as the distance “b” in the present example, a criterion for measuring the distance “b” is not limited thereto.

According to the configuration described above, the distance “a” between the engaged portions 671 assumes a first distance before the sealing member 670 is assembled to the second refrigerant supplying member 620 and assumes a second distance that is longer than the first distance after the sealing member 670 is assembled to the second refrigerant supplying member 620. In other words, when the sealing member 670 is mounted to the second refrigerant supplying member 620, the sealing member 670 is to be mounted to the second refrigerant supplying member 620 in an elasticity-stretched deformed state. As a result, an elastic force acts on the sealing member 670 after the sealing member 670 is mounted and the engaged portion 671 comes into close contact with the engaging portion 621. As a result, the sealing member 670 is less likely to detach from the second refrigerant supplying member 620 and the sealing member 670 can be prevented from falling off during assembly.

In addition, the contact portion 673 of the sealing member 670 is positioned between the plurality of engaged portions 671. More specifically, the contact portion 673 is arranged between the first engaged portion 671a and the second engaged portion 671b in the vertical direction that is a direction in which the contact portion 673 is elasticity stretched when mounted to the second refrigerant supplying member 620. According to the configuration described above, holding the engaged portions 671 and assembling the sealing member 670 enables the sealing member 670 to be mounted without coming into contact with the contact portion 673. As a result, adhesion of dust and the like due to touching the contact portion 673 during assembly can be prevented and a possibility of liquid leaking outside the liquid discharge head 100 can be reduced.

Furthermore, a protruding length of each engaging portion 621 is sufficiently longer than the thickness of the sealing member 670. According to the configuration described above, after the sealing member 670 is mounted, it becomes difficult for the sealing member 670 to disengage from the engaging portion 621. As a result, the sealing member 670 can be prevented from falling off from the second refrigerant supplying member 620 during assembly.

In addition, since the sealing member 670 is mounted in a stretched state, there is a risk that a contact surface of the sealing member 670 deforms and liquid leaks outside the liquid discharge head 100. In the present embodiment, the second opening 674 is provided between the contact portion 673 and the engaged portion 671. The second opening 674 is a through-hole that penetrates the sealing member 670 at a position that is not communicated with the first communication port 622 and the second communication port 632. Providing the second opening 674 enables the second opening 674 to absorb the deformation of the sealing member 670 by deforming and a deformation of the contact portion 673 can be suppressed. As a result, the possibility of liquid leaking outside the liquid discharge head 100 can be reduced.

### First Modification

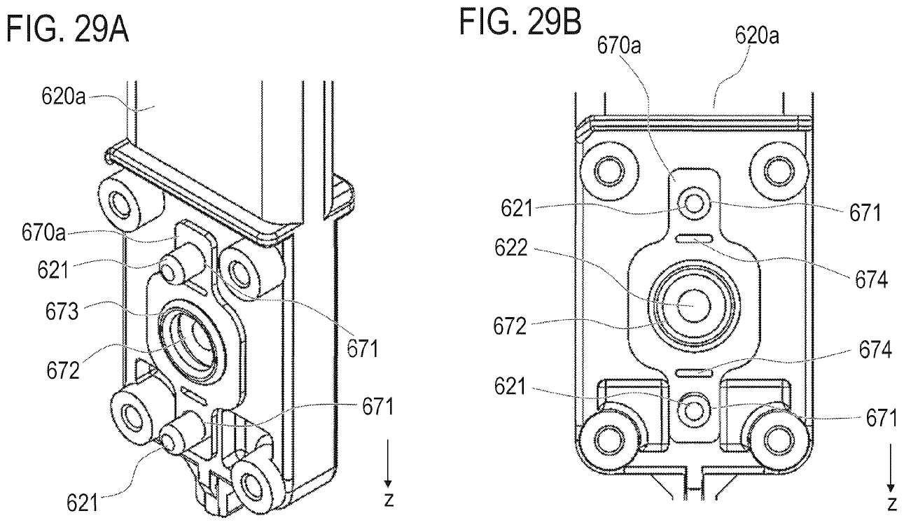

FIGS. 29A and 29B are diagrams showing a first modification of the present embodiment, in which FIG. 29A is a schematic perspective view showing a situation where a sealing member 670a is mounted to a second refrigerant supplying member 620a and FIG. 29B is a front view of FIG. 29A. Here, descriptions of components of the first modification that differ from those of the embodiment described above will be provided and descriptions of components in common with those of the embodiment described above will not be repeated.

While the embodiment described above adopts a configuration in which two each of the opening 672, the first communication port 622, and the second communication port 632 are provided with respect to one sealing member 670, the present invention is not limited thereto. For example, as in the first modification shown in FIGS. 29A and 29B, there may be one or more of the opening 672, the first communication port 622, and the second communication port 632. In addition, while the embodiment described above adopts a configuration in which three each of the engaged portion 671 and the engaging portion 621 are also provided with respect to one sealing member 670, the present invention is not limited thereto. For example, as shown in FIGS. 29A and 29B, there may be at least two or more engaged portions 671 and engaging portions 621 with respect to one sealing member 670a. Due to two or more engaged portions 671 and engaging portions 621 being available, the sealing member 670a is positioned and held with respect to the second refrigerant supplying member 620a. As a result, when assembling the first cooling member 630, the assembling can be performed without any positional shift of the sealing member 670a.

### Second Modification

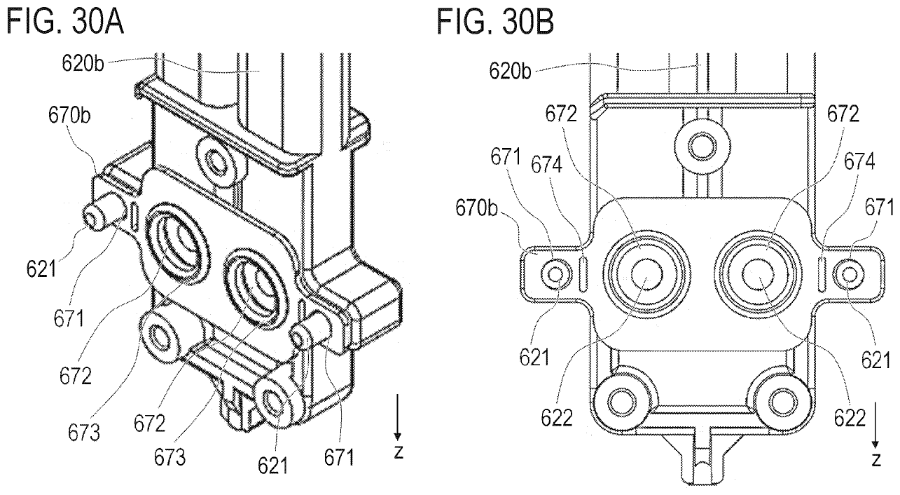

FIGS. 30A and 30B are diagrams showing a second modification of the present embodiment, in which FIG. 30A is a schematic perspective view showing a situation where a sealing member 670b is mounted to a second refrigerant supplying member 620b and FIG. 30B is a front view of FIG. 30A. Here, descriptions of components of the second modification that differ from those of the embodiment described above will be provided and descriptions of components in common with those of the embodiment described above will not be repeated.

While the embodiment described above adopts a configuration in which the sealing member 670 is mounted to the second refrigerant supplying member 620 while being stretched in the vertical direction, the present invention is not limited thereto. For example, as shown in FIGS. 30A and 30B, a configuration may be adopted in which the sealing member 670b is mounted to a second refrigerant supplying member 620b while being stretched in a direction perpendicular to the vertical direction.

### Third Modification

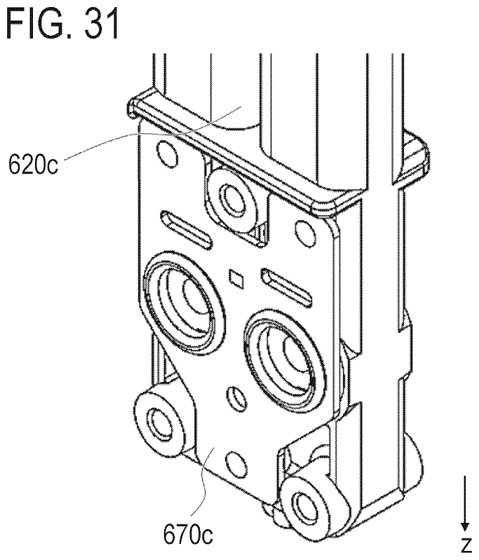

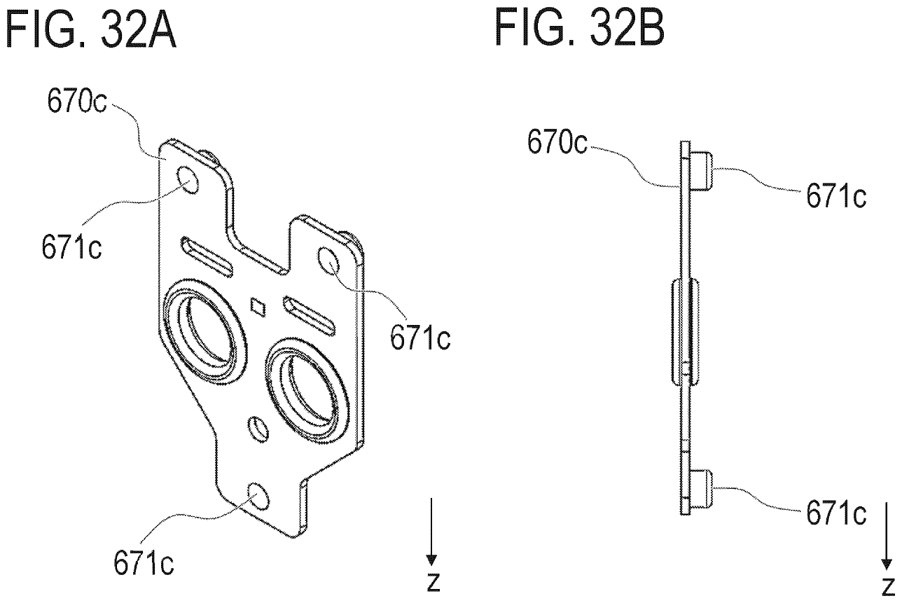

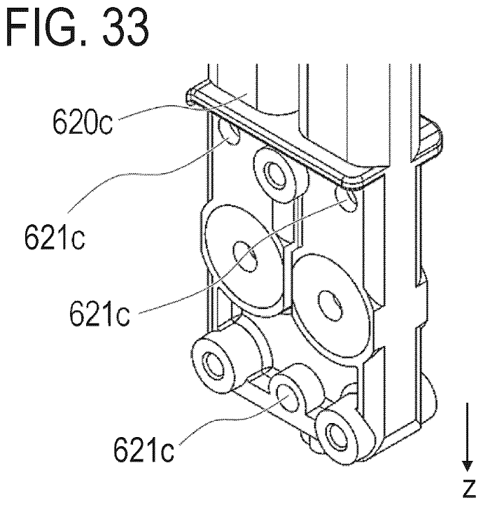

FIG. 31 is a diagram which shows a third modification of the present embodiment and which is a schematic perspective view showing a situation where a sealing member 670c is mounted to a second refrigerant supplying member 620c. In addition, FIGS. 32A and 32B are diagrams showing the sealing member 670c according to the third modification, in which FIG. 32A shows a schematic perspective view of the sealing member 670c and FIG. 32B shows a side view in FIG. 32A. FIG. 33 shows a schematic perspective view of the second refrigerant supplying member 620c according to the third modification. Here, descriptions of components of the third modification that differ from those of the embodiment described above will be provided and descriptions of components in common with those of the embodiment described above will not be repeated.

While the embodiment described above adopts a configuration in which each engaged portion 671 has a round hole shape and each engaging portion 621 has a boss shape, the present invention is not limited thereto. For example, as shown in FIGS. 31 to 33, each engaged portion 671c of the sealing member 670c has a convex shape (protruded portion) and each engaging portion 621c of the second refrigerant supplying member 620c has a concave shape (depressed portion) corresponding to the shape of the engaged portion 671c (into which the engaged portion 671c is insertable). As described above, the engaged portion 671c and the engaging portion 621c may have any shape that prevents the sealing member 670c from falling off from the second refrigerant supplying member 620c when the sealing member 670c is mounted to the second refrigerant supplying member 620c.

### Fourth Modification

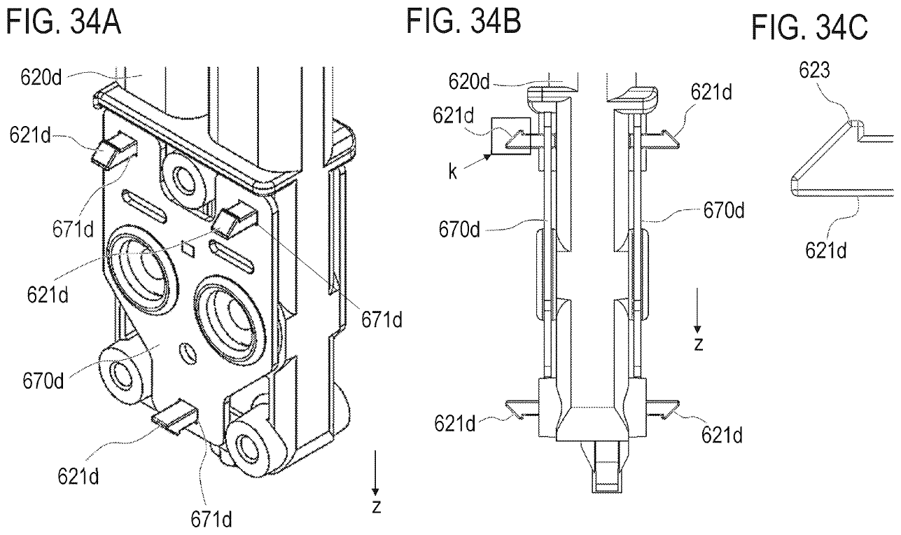

FIGS. 34A to 34C are diagrams showing a fourth modification of the present embodiment, in which FIG. 34A is a schematic perspective view showing a situation where a sealing member 670d is mounted to a second refrigerant supplying member 620d, FIG. 34B is a side view of FIG. 34A, and FIG. 34C is an enlarged view of portion k in FIG. 34B. Here, descriptions of components of the fourth modification that differ from the embodiment described above will be provided and descriptions of components in common with those of the embodiment described above will not be repeated.

An engaging portion 621d of the second refrigerant supplying member 620d has an engaging protruded portion 623 that protrudes in a direction intersecting an insertion direction of the engaging portion 621d as a projected portion corresponding to an engaged portion 671d as a hole portion of the sealing member 670d. The engaging protruded portion 623 is provided in a portion having passed through the engaged portion 671d that is a hole portion in the engaging portion 621d (a distal end-side portion of the engaging portion 621d as a projected portion). According to the configuration described above, when the sealing member 670d is about to fall off from the second refrigerant supplying member 620d, the sealing member 670d can be prevented from falling off from the second refrigerant supplying member 620d by being caught by the engaging protruded portion 623.

### Fifth Modification

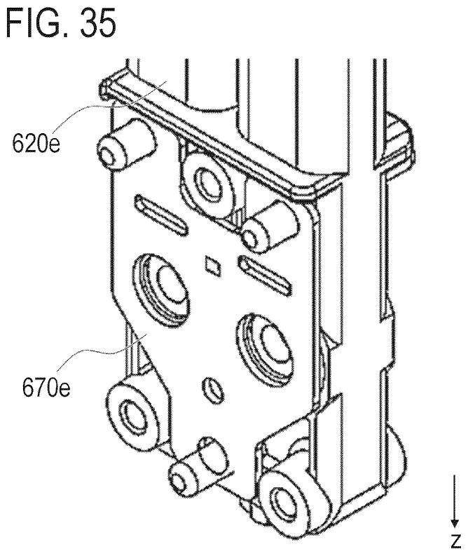

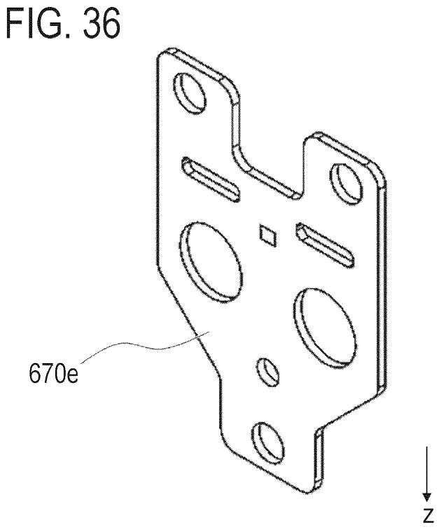

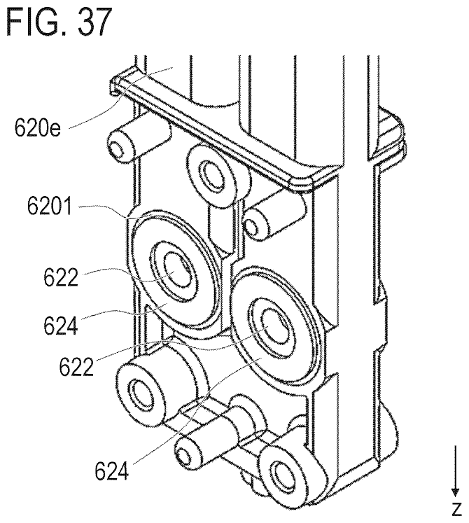

FIG. 35 is a diagram which shows a fifth modification of the present embodiment and which is a schematic perspective view showing a situation where a sealing member 670e is mounted to a second refrigerant supplying member 620e. In addition, FIG. 36 is a schematic perspective view of the sealing member 670e according to the fifth modification and FIG. 37 is a schematic perspective view of the second refrigerant supplying member 620e according to the fifth modification. Here, descriptions of components of the fifth modification that differ from the embodiment described above will be provided and descriptions of components in common with those of the embodiment described above will not be repeated.

While the embodiment described above adopts a configuration in which the sealing member 670 is provided with the contact portion 673 and the contact portion 673 comes into contact with the second refrigerant supplying member 620 and the first cooling member 630, the present invention is not limited thereto. For example, as shown in FIGS. 35 to 37, a configuration may be adopted in which the second refrigerant supplying member 620e is provided with a contact protruded portion 624 as a contact portion and a fluidic connection is established as the sealing member 670e and the contact protruded portion 624 come into contact with each other. The contact protruded portion 624 is provided on a mounting surface of the sealing member 670e in the second refrigerant supplying member 620e so as to surround the first communication port 622 and to protrude from the mounting surface. Although a description will not be provided, the first cooling member 630 is also provided with a contact protruded portion configured in a similar manner to the contact protruded portion 624.

### Sixth Modification

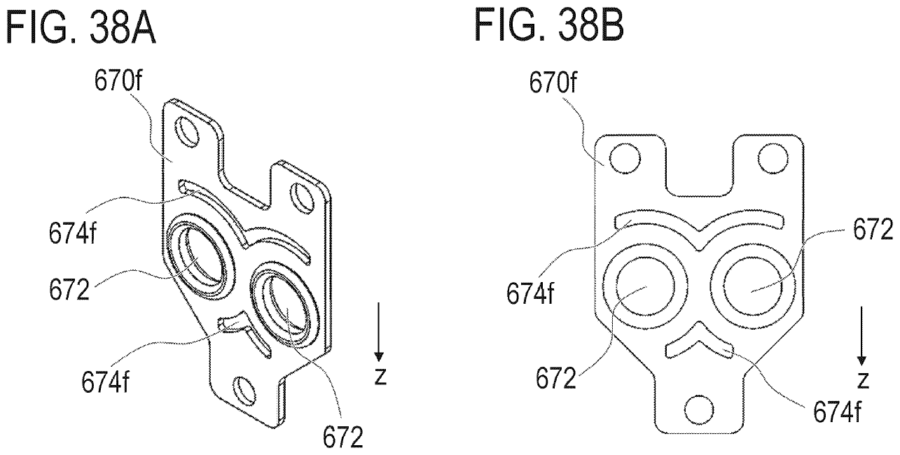

FIGS. 38A and 38B are diagrams showing a sixth modification of the embodiment described above, in which FIG. 38A shows a schematic perspective view of a sealing member 670f according to the sixth modification and FIG. 38B shows a front view in FIG. 38A. Here, descriptions of components of the sixth modification that differ from the embodiment described above will be provided and descriptions of components in common with those of the embodiment described above will not be repeated.

While the embodiment described above adopts a configuration in which the second opening 674 in the sealing member 670 is constituted of two long holes and one round hole, the present invention is not limited thereto. For example, as shown in FIGS. 38A and 38B, a second opening 674f may be an arc hole having an arc-like opening shape that extends in a direction along an outer circumferential direction of the opening 672. The second opening 674f according to the present modification is configured as if two arc holes corresponding to each of two openings 672 are connected. In other words, as the shape of the second opening 674f, any shape may be adopted as long as the shape is a hole shape enabling a deformation that absorbs deformation of the sealing member 670f while suppressing deformation of the contact region 673 when the sealing member 670f is mounted to the second refrigerant supplying member 620 while being stretched.

As described above, in a liquid discharge head, when a fluidic connection is made between head components in a direction perpendicular to the vertical direction, there is a risk that the sealing member will fall off during assembly. In addition, touching the contact surface of the sealing member during assembly may cause dust and the like to adhere to the contact surface, resulting in leakage of liquid from a flow path connecting portion to the outside of the liquid discharge head. With the liquid discharge head according to the present embodiment, the sealing member can be stably held at a predetermined mounting position relative to a flow path member during head assembly. Accordingly, during head assembly, assemblability and reliability when making a fluidic connection using the sealing member in a direction perpendicular to the vertical direction can be improved.

While an example of applying the present invention to the sealing member 670 used in a flow path for circulating a refrigerant in a liquid discharge head has been described in the embodiment and the respective modifications presented above, a range of application of the present invention is not limited thereto. In other words, the present invention may be applied to a sealing member that is used in a liquid supply flow path for supplying a liquid (ink) discharged from a discharge port toward the discharge port.

While an example of applying the present invention to a sealing member that is sandwiched in a horizontal direction orthogonal to a vertical direction between two flow path members has been described in the embodiment and the respective modifications presented above, a range of application of the present invention is not limited thereto. In other words, the present invention may be applied to a sealing member configured to be sandwiched in a direction (inclined direction) at an angle to both the vertical direction and the horizontal direction between two flow path members. In addition, the present invention may be applied to a sealing member configured to be sandwiched in the vertical direction between two flow path members. Even in a configuration that is stacked in the vertical direction, the sealing member can be reliably positioned and assemblability of the liquid discharge head can be improved.

Configurations of the embodiment and the respective modifications described above can be combined with each other.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-007624, filed on Jan. 22, 2024, which is hereby incorporated by reference herein in its entirety.

What is claimed is:

1. A liquid discharge head, comprising:
a first flow path member including a first communication hole;
a second flow path member including a second communication hole; and
a sealing member which includes an opening portion that forms a flow path connecting the first communication hole and the second communication hole with each other and which is interposed between the first flow path member and the second flow path member,
wherein the first flow path member includes a mounting surface on which the first communication hole opens and which extends along a vertical direction and an engaging portion,
wherein the sealing member includes an engaged portion with which the engaging portion is engageable and the sealing member is fixed to the first flow path member along the mounting surface due to an engagement of the engaging portion and the engaged portion.

2. The liquid discharge head according to claim 1,
wherein the engaging portion is a projected portion which protrudes from the mounting surface,
wherein the engaged portion is a hole portion into which the projected portion is insertable.

3. The liquid discharge head according to claim 2,
wherein the projected portion includes a protruded portion which protrudes in a direction intersecting with an insertion direction relative to the hole portion in a part having passed through the hole portion.

4. The liquid discharge head according to claim 1,
wherein the engaging portion is a depressed portion which is depressed from the mounting surface,
wherein the engaged portion is a protruded portion which is insertable into the depressed portion.

5. The liquid discharge head according to claim 1,
wherein the sealing member is assembled so as to be sandwiched between the first flow path member and the second flow path member in a direction perpendicular to the mounting surface.

6. The liquid discharge head according to claim 1,
wherein the engaging portion includes a first engaging portion and a second engaging portion provided at a position that differs from the first engaging portion,
wherein the engaged portion includes a first engaged portion that corresponds to the first engaging portion and a second engaged portion that corresponds to the second engaging portion.

7. The liquid discharge head according to claim 6,
wherein a distance between the first engaged portion and the second engaged portion is
a first distance before the sealing member is assembled to the first flow path member, and
a second distance that is longer than the first distance after the sealing member is assembled to the first flow path member.

8. The liquid discharge head according to claim 7,
wherein in a case where the mounting surface is considered as a first mounting surface,
the second flow path member includes a second mounting surface on which the second communication hole opens and which extends along a vertical direction,
wherein the sealing member includes:
a first contact portion which is provided so as to surround the opening portion in an area that opposes the first mounting surface and which comes into contact with the first mounting surface; and
a second contact portion which is provided so as to surround the opening portion in an area that opposes the second mounting surface and which comes into contact with the second mounting surface.

9. The liquid discharge head according to claim 8,
wherein the first contact portion and the second contact portion are provided between the first engaged portion and the second engaged portion.

10. The liquid discharge head according to claim 9,
wherein the first contact portion is provided so as to protrude from a first opposing surface of the sealing member which opposes the first mounting surface,
wherein the second contact portion is provided so as to protrude from a second opposing surface of the sealing member which opposes the second mounting surface.

11. The liquid discharge head according to claim 1,
wherein the sealing member includes an opposing surface which opposes the mounting surface,
wherein the first flow path member includes a contact portion which surrounds the first communication hole on the mounting surface, which is provided so as to protrude from the mounting surface, and which comes into contact with the opposing surface.

12. The liquid discharge head according to claim 1,
wherein the sealing member includes, between the engaged portion and the opening, a second opening portion which is not communicated with the first communication hole and the second communication hole and which penetrates the sealing member.

13. The liquid discharge head according to claim 1,
further comprising:
a discharge port for discharging a liquid; and
a liquid supply flow path for supplying the liquid toward the discharge port,
wherein a flow path formed by the first flow path member, the second flow path member, and the sealing member is a flow path that differs from the liquid supply flow path.

14. The liquid discharge head according to claim 13,
wherein a flow path formed by the first flow path member, the second flow path member, and the sealing member is a flow path for circulating a refrigerant.

15. A recording apparatus, comprising a liquid ejection head,
the liquid ejection head, comprising:
a first flow path member including a first communication hole;
a second flow path member including a second communication hole;
a sealing member which includes an opening portion that forms a flow path connecting the first communication hole and the second communication hole with each other and which is interposed between the first flow path member and the second flow path member;
a discharge port for discharging a liquid; and
a liquid supply flow path for supplying the liquid toward the discharge port,
wherein the first flow path member includes a mounting surface on which the first communication hole opens and which extends along a vertical direction and an engaging portion,
wherein the sealing member includes an engaged portion with which the engaging portion is engageable and the sealing member is fixed to the first flow path member along the mounting surface due to an engagement of the engaging portion and the engaged portion,
wherein a flow path formed by the first flow path member, the second flow path member, and the sealing member is a flow path that differs from the liquid supply flow path, and
wherein recording is performed by causing ink to be discharged onto a recording medium from the discharge port of the liquid discharge head.
